(19) United States
(12) Patent Application Publication
(10) Pub. No.: US 2006/0157896 A1
(43) Pub. Date: Jul. 20, 2006

(54) Method and apparatus for producing bottles and preforms having a crystalline neck

(76) Inventors: Robert A. Lee, Bowdon (GB); Gerald A. Hutchinson, Coto De Caza, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 11/255,764

(22) Filed: Oct. 21, 2005

Related U.S. Application Data
(60) Provisional application No. 60/621,373, filed on Oct. 22, 2004.

(51) Int. Cl. B29C 71/02; B29C 71/04

(52) U.S. Cl. 264/345; 264/346; 264/492; 425/525; 425/526; 425/528

(57) ABSTRACT

Disclosed are plastic preforms and containers in which the materials in the neck, neck finish and/or neck cylinder are at least partially in the crystalline state and the body is primarily in the amorphous or semi-crystalline state. This structure in a preform enables the preform to be easily blow molded by virtue of the amorphous material in the body, while maintaining dimensional stability in hot-fill applications. In addition, the amorphous inner surface of the neck finish stabilizes the post mold dimensions allowing closer molding tolerances than other crystallizing processes. The crystallized outer surface of the preform supports the amorphous structure during high temperature filling of the container. Physical properties are also enhanced as a result of this unique crystalline/amorphous structure.

### RELATED APPLICATIONS

This application claims the priority benefit under 35 U.S.C. § 119(e) of the provisional application 60/621,373, filed Oct. 22, 2004, which is hereby incorporated by reference in its entirety.

### BACKGROUND OF THE INVENTION

1. Field of the Invention

This invention relates to preforms and containers such as for containing beverages and the like. More specifically, this invention relates to methods and apparatuses for producing preforms and plastic bottles, preferably comprising polyethylene terephthalate (PET), in which the materials in the neck, neck finish and/or neck cylinder are at least partially in a substantially crystalline state.

2. Description of the Related Art

The use of plastic containers as a replacement for glass or metal containers in the packaging of beverages has become increasingly popular. The advantages of plastic packaging include lighter weight, decreased breakage as compared to glass, and potentially lower costs. The most common plastic used in making beverage containers today is PET. Virgin PET has been approved by the FDA for use in contact with foodstuffs. Containers made of PET are transparent, thin-walled, lightweight, and have the ability to maintain their shape by withstanding the force exerted on the walls of the container by pressurized contents, such as carbonated beverages. PET resins are also fairly inexpensive and easy to process.

Most PET bottles are made by a process which includes the blow-molding of plastic preforms which have been made by processes including injection molding. In some circumstances, it is preferred that the PET material in plastic preforms is in an amorphous or semi-crystalline state because materials in this state can be readily blow-molded, whereas fully crystalline materials generally cannot. However, bottles made entirely of amorphous PET may not have enough dimensional stability during a standard hot-fill process due to the relatively low glass transition temperature, Tg, of the PET material and the tight tolerances required when using standard threaded closures. In these circumstances, a bottle comprising crystalline PET would be preferred, as it would hold its shape during hot-fill processes. Unfortunately, typical preforms may have a microstructure that is not suitable for blow molding or hot fill.

### SUMMARY OF THE INVENTION

The present disclosure provides a plastic bottle, which has the advantages of both a crystalline bottle and an amorphous or semi-crystalline bottle. By making at least part of the uppermost portion of the preform substantially crystalline while keeping the body of the preform amorphous or semi-crystalline (sometimes referred to herein as “non-crystalline”), one can make a preform that will blow-mold easily yet retain necessary dimensions in the crucial neck area during a hot-fill process. The preform and bottle may be made solely of PET or another material, preferably a polyester, or it may further comprise other materials, including barrier materials and/or oxygen scavenger materials to prevent carbonated beverages or oxygen-sensitive products contained within the bottle from going “flat” or spoiling.

In preferred embodiments, a heat treatment system for crystallizing a portion of a preform comprises a heat source configured to change the temperature of a preform. A mandrel is adapted to hold a preform while the heat source heats at least a portion of the preform to a crystallization temperature suitable for crystallizing the at least a portion of the preform. In one variation, a preform is held by the mandrel and has a neck portion and a body portion. After the heat source heats the preform, the body portion comprises a non-crystalline material, and the neck portion comprises crystalline material. In one embodiment, the body portion is primarily non-crystalline, and the neck portion is primarily crystalline.

In some embodiments, a heat treatment system for crystallizing a portion of a preform is provided. The heat treatment system comprises an energy source configured to output thermal energy. A mandrel is adapted to hold a preform such that the preform is heated to a crystallization temperature to reduce the amount of amorphous material of the preform when the energy source outputs a predetermined amount of thermal energy.

In some embodiments, a heat treatment system for crystallizing a portion of a preform is provided. The system comprises a thermal processing system and a transport system. The thermal processing system is configured to output thermal energy. The transport system comprises a plurality of carriers. Each carrier is movable along a processing line extending alongside the thermal processing system. Each carrier has at least one mandrel that is adapted to hold a preform while the thermal processing system outputs a sufficient amount of thermal energy to cause crystallization of at least a portion of the preform to reduce the amount of amorphous material of the preform.

In some embodiments, a method for crystallizing a preform is provided. The method comprises holding a preform comprising amorphous material by a carrier that moves the preform along a processing line. The preform is moved by a thermal processing system. At least a portion of the preform is heated with the thermal processing system until the amorphous material by weight percentage of the preform has been reduced.

In one arrangement, the heat source comprises one or more lamps. For example, the heat source may be a bank of IR lamps. The heat source is preferably movable relative to a preform held by a carrier.

In some embodiments, a method of heating a preform is provided. The method comprises holding a preform on a mandrel. The preform has a neck finish portion comprising primarily amorphous material and a body portion comprising primarily amorphous material. Thermal energy is delivered to the preform until the body portion of the preform is primarily amorphous or semi-crystalline and the neck finish portion is primarily crystalline. In some variations, the thermal energy is infrared radiation. If desired, the infrared radiation can be outputted from one or more infrared lamps.

### BRIEF DESCRIPTION OF THE DRAWINGS

FIG. 1 illustrates a preform that can be thermally processed to produce semi-crystalline or crystalline material.

FIG. 2 is a cross-sectional view of the preform of FIG. 1.

FIG. 2A is an enlarged cross-section of a neck finish of the preform of FIG. 2 taken along 2A-2A in accordance with some embodiments.

FIG. 3 is a plan view of a thermal processing system for processing preforms, and the processing system having a carousel and a heat treatment system.

FIG. 4 is a side view of a preform held by a carrier that may be used with the carousel of FIG. 3.

FIG. 4A is a side view of a carrier without a mandrel and associated preform.

FIG. 4B is a back view of the carrier of FIG. 4A.

FIG. 5 illustrates a mandrel attached to the carrier of FIG. 4A, wherein a split ring of the mandrel is shown removed.

FIG. 6 is a cross-sectional view of the preform of FIG. 1 on the mandrel of FIG. 5.

FIG. 7 is a cross-sectional view of a heat treatment system of FIG. 3 taken along the line 7-7, and a preform positioned for processing.

FIG. 7A is a side view of the heat treatment system of FIG. 7.

FIG. 8 is a cross-sectional view of a modified heat treatment system that is processing a preform.

FIG. 9 illustrates a modified heat treatment system for processing preforms.

FIG. 10 illustrates a cooling system for cooling a preform.

FIG. 11 is a plan view of an embodiment of a thermal processing system for processing preforms.

FIG. 12 is a cross-sectional view of the thermal processing system of FIG. 11 taken along a line 12-12.

### DETAILED DESCRIPTION OF THE PREFERRED EMBODIMENT

Disclosed herein are various methods and apparatuses for producing articles comprising semi-crystalline and/or crystalline material. In some non-limiting embodiments, at least a portion of an article comprises a semi-crystalline and/or crystalline material to achieve one or more desired properties. To form the article, the at least a portion of the preform can be formed by heating the at least a portion of the preform above a crystallization temperature. In some embodiments, at least a portion of the article is adapted to contact food or liquid and comprises a formable material, such as PET, that may impart substantially no flavor to the food or liquid. For example, the article can be a preform, a container, a closure, packaging, a tube, a sheet, and the like. However, for the sake of simplicity, these embodiments will be described herein primarily as articles or by an individual article name. It is to be understood in many cases that other articles may be substituted for the named article.

The preferred embodiments described herein generally produce preforms with a semi-crystalline or crystalline neck finish, which are typically then blow-molded into beverage containers. The preforms may be monolayer; that is, the preforms can be comprised of a single layer of a base material, or they may be multilayer, including, but not limited to, those which comprise a combination of a base material and another material. The material in such layers may be a single material or it may be a blend of one or more materials so as to include blends of polymers and/or one or more oxygen scavenging materials. The provision of one or more barrier layers, or the inclusion of one or more oxygen scavengers in one or more layers, is generally desirable when the container is to be filled with a carbonated beverage or oxygen sensitive product. The barrier layer may serve to prevent the ingress of oxygen into the container or the egress of carbon dioxide from the container. Additionally, multiple barrier layers may be provided to refine barrier properties or provide desirable structural properties. The preforms can also have other layers that perform other functions.

The preforms and containers made therefrom can have one or more of the following advantageous characteristics: an insulating layer, a gas barrier layer, UV protection layers, protective layer (e.g., a vitamin protective layer, scuff resistance layer, etc.), a foodstuff contacting layer, a non-flavor scalping layer, non-color scalping layer, a high strength layer, a compliant layer, a tie layer, a gas scavenging layer (e.g., oxygen, carbon dioxide, etc), a layer or portion suitable for hot fill applications, a layer having a melt strength suitable for extrusion, strength, recyclable (post consumer and/or post-industrial), clarity, etc. In one embodiment, the monolayer or multi-layer material comprises one or more of the following materials: PET (including recycled and/or virgin PET), PETG, foam, polypropylene, phenoxy type thermoplastics, polyolefins, phenoxy-polyolefin thermoplastic blends, and/or combinations thereof.

By achieving a crystallized state in the neck portion of the preform before processing (e.g., blow molding and hot-filling), the final dimensions of the neck portion of a container can be substantially identical to the initial dimensions of the preform. Therefore, dimensional variations are minimized and dimensional stability is improved, especially if the preform is heated to elevated temperatures. Advantageously, this results in improved tolerances of the threads on the neck finish so that a closure or cap can be fastened to the blow-molded container. Preforms having other configurations can also be processed to form crystalline material. By way of example, preforms can have neck finishes configured to receive snap caps, or closures of other configurations. Accordingly, preforms may or may not have threads depending on the end use of the container made therefrom. Any of these preforms made of amorphous material, including their neck finishes, can be thermally processed to form preforms with semi-crystalline or crystalline neck finishes.

In some embodiments, preforms may have both substantially crystalline and substantially amorphous or substantially semi-crystalline regions. A preform which has both crystalline and amorphous or semi-crystalline regions is shown in U.S. Pat. No. 6,217,818 to Collete et al. However, the preform of Collete et al. is constructed using a separately formed crystalline neck portion, which is then placed into a second cavity which forms an amorphous body portion of the preform. This preform may have undesirable structural properties.

While a preform having a non-crystalline body portion is preferred for blow-molding, a bottle having greater crystalline character in the neck portion is preferred for its dimensional stability during various stages of high temperature packaging processes, such as a hot-fill process. Accordingly, a preform constructed according to some embodiments has a generally non-crystalline body portion and a crystalline neck portion. To create generally crystalline and non-crystalline portions in the same preform, different levels of heating and/or cooling can be used to achieve the desired preform microstructure. The different levels of heating and/or cooling may be preferably maintained by thermal isolation of one or more regions of the preform. For example, thermal isolation of the preform's neck region can be accomplished by utilizing a combination of energy sources (e.g., heat lamps), cooling mandrels, and/or other suitable devices as discussed below. A crystalline neck finish can be formed from an amorphous neck finish by heating the neck finish to an elevated temperature suitable for forming a crystalline microstructure. The neck finish can then be slowly cooled to form crystalline material. The cooling rate can vary based on material properties. The body portion of a preform can be maintained below a target temperature to ensure that the body portion remains amorphous, even when the neck finish is crystallized.

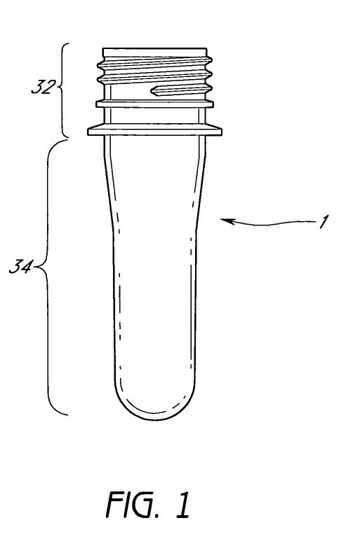

Referring to FIG. 1, a preferred preform 1 is depicted. The preform is preferably made of an FDA approved material such as virgin PET and can be of any of a wide variety of shapes and sizes. The preform shown in FIG. 1 is a 24 gram preform of the type which will form a 16 oz. carbonated beverage bottle, but as will be understood by those skilled in the art, other preform configurations can be used depending upon the desired configuration, characteristics and use of the final article. The preform 1 may be made by injection molding as is known in the art or by other suitable methods.

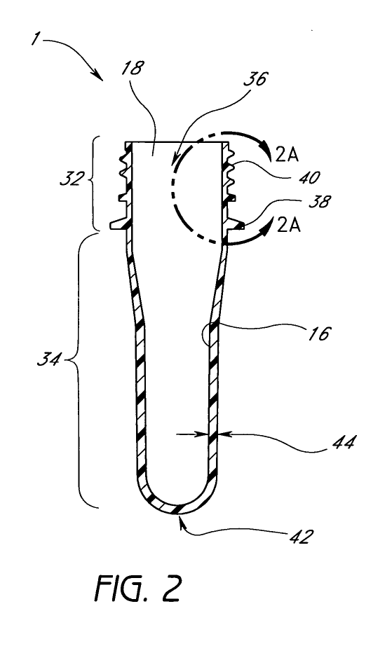

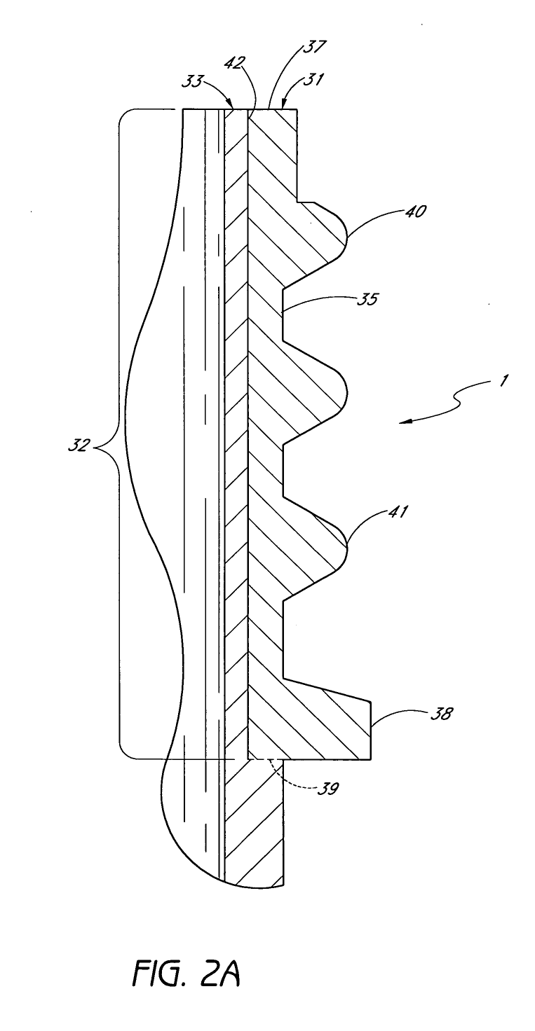

Referring to FIG. 2, a cross-section of the preferred preform 1 of FIG. 1 is depicted. The preform 1 has a neck portion 32 and a body portion 34. The neck portion 32, also called the neck finish, begins at the opening 18 to the interior of the preform 1 and extends to and includes the support ring 38. The neck 32 is further characterized by the presence of the threads 40, which provide a way to fasten a cap onto a container produced from the preform 1. The body portion 34 is an elongated and cylindrically shaped structure extending down from the neck 32 and culminating in the rounded end cap 42. The preform thickness 44 will depend upon the overall length of the preform 1 and the wall thickness and overall size of the resulting container. It should be noted that as the terms “neck” and “body” are used herein, in a container that is colloquially called a “longneck” container, the elongated portion just below the support ring 38, threads 40, and/or lip where the cap is fastened would be considered part of the “body” of the container and not a part of the “neck.”

Conventional preforms may have a microstructure resulting in the preforms not being suitable for blow molding and then hot-filling. For example, conventional preforms may have a neck portion 34 made entirely of amorphous material (e.g., amorphous PET). A container made from one of these preforms will likewise have an amorphous neck. These containers may have low dimensional stability during, e.g., a standard hot-fill process, or other high temperature processes. If the amorphous neck reaches a sufficiently high temperature, the neck may deform and become unsuitable for receiving a closure. As such, these containers may be unsuitable for many applications where a closure needs to be applied to the container. The systems and methods disclosed herein can be used to form preforms with a semi-crystalline or crystalline neck finish.

Suitable preforms for use with the disclosed embodiments can be purchased from Ball Corporation (Colorado). However, there are many suitable PET and non-PET preforms that can be processed with the disclosed thermal processing systems to obtain a preform with a desired microstructure. PET preforms can exist in crystalline, semi-crystalline, and amorphous forms. However, in preferred embodiments, the crystallinity of the PET in the body portion 34 may be minimized and the amorphous state maximized in order to create a semi-crystalline or crystalline state which, among other things, facilitates the blow molding process. Methods and apparatuses for making preforms are described in U.S. Pat. No. 6,391,408 entitled COATED POLYESTER PREFORMS AND METHOD OF MAKING SAME and pending U.S. patent application Ser. No. 10/614,731 entitled DIP, SPRAY, AND FLOW COATING PROCESS FOR FORMING COATED ARTICLES, and U.S. patent application Ser. No. 11/179,025 entitled COATING PROCESS AND APPARATUS FOR FORMING COATED ARTICLES; which are hereby incorporated by reference in their entireties and form part of the disclosure of the present application. The disclosed thermal processing system 312 can be used to thermally process monolayer or multilayer preforms disclosed in these incorporated references.

The illustrated preform 1 has the neck portion 32 that comprises crystalline material. In some embodiments, including the embodiment of FIG. 2A, the neck portion 32 comprises a first portion 31 and a second portion 33. The first portion 31 can define an outer surface 35 of the preform 1. The first portion 31 can extend from an upper end 37 to the support ring 38. In some embodiments, the preform 1 can have a transition portion 39 (shown in phantom) that transitions between crystalline and non-crystalline material.

The first portion 31 surrounds the second portion 33 and preferably comprises crystalline material, and more preferably comprises primarily crystalline material. In some non-limiting embodiments, the first portion 31 comprises about 50% by weight, also including more than about 60%, 70%, 80%, 90%, or 95% by weight, of crystalline material. The crystalline material of the first portion 31 can be evenly or unevenly distributed. The first portion 31 can have any suitable amount of crystalline material based on the desired manufacturing process or a particular end use for the container made from the preform 1. The percentage of crystalline material can be increased to improve the dimensional stability of the neck finish during high temperature applications, such as hot-fill processes.

Optionally, the first portion 31 can define structures or threads 40 that preferably comprise substantially crystalline material. Thus, after the preform 1 has been blow molded, the structures or threads 40 may retain their original configuration so that they can receive a closure or cap.

The transition portion 39 can comprise material that is generally similar to the material forming the first portion 31, and preferably transitions to material that is generally similar to the material forming the body 34. In the illustration of FIG. 2A, the transition portion 39 is spaced from the upper end 37 of the preform 1. In some embodiments, the transition portion 39 is located below most of the structures or threads 40. For example, the transition portion 39 can be located below the lowest thread 41. In one embodiment, the transition portion 39 is located proximate to the support ring 38. In the illustrated embodiment, the transition portion 39 is located near the lower surface of the support ring 38. Alternatively, the transition portion 39 can be spaced below the support ring 38 at some point along the body 34.

A transition portion 42 can be located between the first portion 31 and second portion 33. The transition portion 42 can comprise material that is similar to the material of the first portion 31 and can transition to material that is similar to material forming the second portion 33. However, in some embodiments, the neck finish 32 is made entirely of crystalline material, if desired.

With continued reference to FIG. 2A, the second portion 33 can be comprised of non-crystalline material and can form a generally uniform layer disposed between the interior of the preform 1 and the first portion 31. However, in some embodiments, a second portion 33 can have a generally non-uniform cross-section and can extend from the body 34 to the end 37. In some embodiments, the second portion 33 can be made substantially of semi-crystalline material. Alternatively, the second portion 33 can be made substantially of amorphous material. One of ordinary skill in the art can determine the desired crystallinity of the second portion 33 depending on the application.

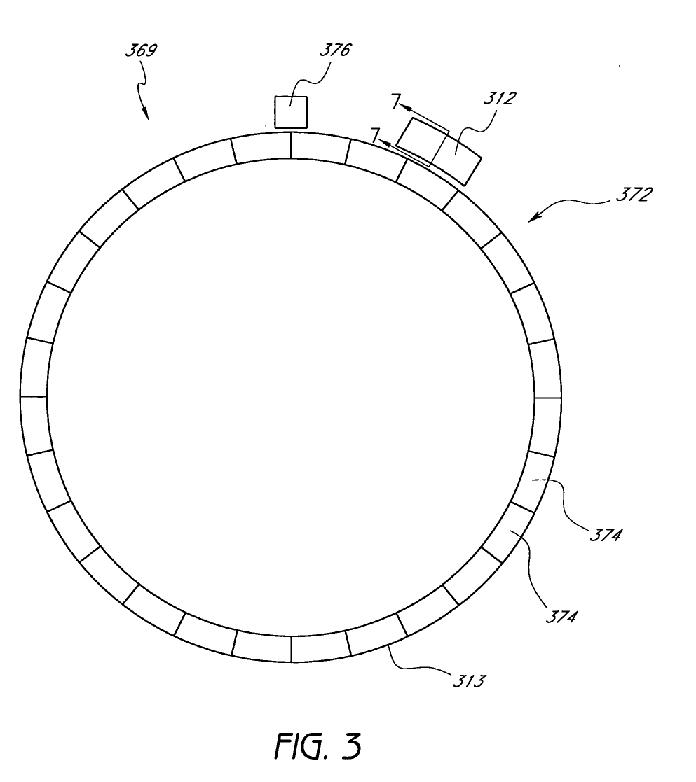

With respect to FIG. 3, a thermal processing system 369 can be used to produce an article having one or more portions that are amorphous, semi-crystalline, crystalline, or combinations thereof. The illustrated thermal processing system 369 includes a heat treatment system 312 that can selectively thermally process portions of articles (e.g., preforms) to achieve the desired characteristics of the article. A carousel system 372 can carry the preforms along a processing line past the heat treatment system 312. The thermal processing system 369 can be utilized to produce preform with a crystalline neck finish, such as the neck finish illustrated in FIG. 2A.

The heat treatment system 312 of FIG. 3 can be positioned alongside the carousel system 372. The carousel system 372 comprises carriers 374 positioned about its periphery. These carriers are configured to grip and hold one or more preforms, and can move about the periphery of a carousel system 372 while holding the preforms. As the preforms travel past the heat treatment system 312, the preforms are heated to form preforms with the desired amount of crystalline material. The carriers 374 can move clockwise or counter-clockwise about the carousel system 372, as desired.

A transfer mechanism 376 of the carousel system 372 can deliver preforms to and/or receive preforms from the carousel 313. The transfer mechanism 376 can batch feed or continuously feed preforms to the carousel system 372, and can be any mechanism or delivery device suitable for receiving and/or delivering preforms. For example, the transfer mechanism 376 can be a starwheel assembly that delivers preforms to the moving carriers 374. In one embodiment, the transfer mechanism 376 can have one device for delivering unprocessed preforms to the carousel system 372 and another device for receiving the processed preforms. The unprocessed preforms can be amorphous preforms, and the processed preforms can have a crystalline neck finish. In alternative embodiments, preforms can be manually fed to the carousel system 372.

When the carousel 313 is rotating, the transfer mechanism 376 can deliver preforms to the carriers 374 as the carriers 374 move about the carousel 313. The carriers 374 can move at any suitable line speed based on the desired thermal processing and settings of the heat treatment system 312. For example, the line speed of the carriers 374 can be increased or decreased if the heat output of the heat treatment system 312 is increased or decreased, respectively.

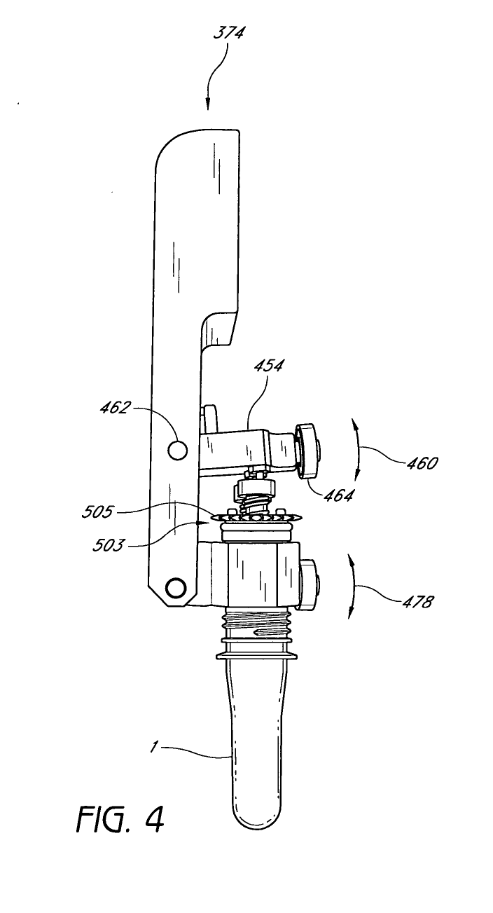

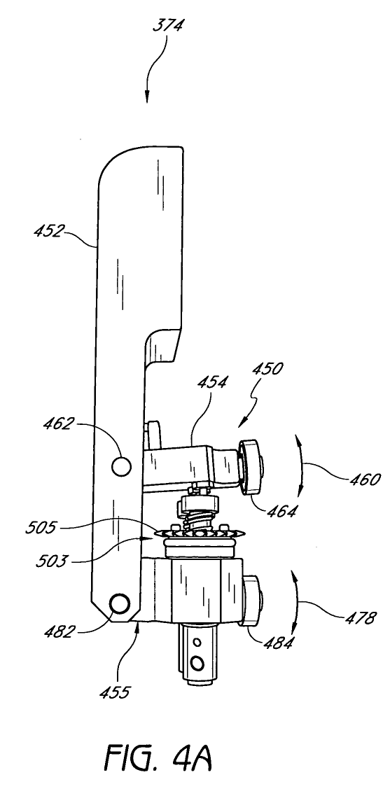

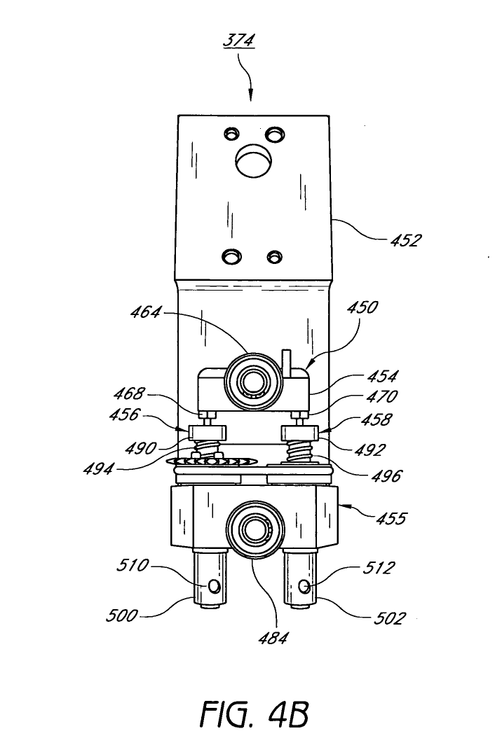

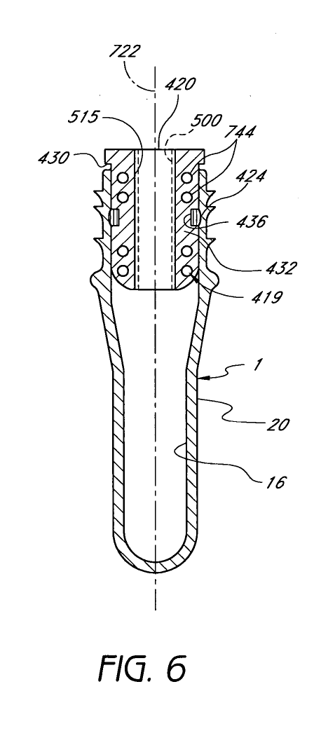

As shown in FIG. 4, the carrier 374 is adapted to hold at least one preform 1. As illustrated in FIGS. 4 and 6, the carrier 374 can have a mandrel 420 that engages an inner portion (e.g., an interior surface 16) of a preform. The carrier 374 can hold the preform 1 in the illustrated position as the carrier 374 moves about the carousel 313.

With respect to FIGS. 4A and 4B, the carrier 374 can have a lever system 450 for controlling the movement of the mandrel. The carrier 374 of FIGS. 4A and 4B is shown with the mandrels removed. The lever system 450 can be articulated to cause the mandrel 420 (FIG. 6) to grip and release a preform, as desired. In the illustrated embodiment, the lever system 450 is attached to the body 452 of the carrier 374. The lever system 450 preferably comprises a lever 454, a base 455, and rods 456, 458 (FIG. 4B).

The lever 454 can be rotated in the direction indicated by the arrows 460 and extends from a pivot 462, as shown in FIG. 4A. The end of the lever 454 can have a roller 464 for engaging a track positioned along the periphery of the carousel 313. Contact pads 468, 470 can contact the upper ends of the rods 456, 458, respectively, as shown in FIG. 4B.

As shown in FIGS. 4 and 4A, the base 455 can be rotated in the direction indicated by the arrows 478 and extends from a pivot 482. The end of the base 455 can have a roller 484 for engaging a track positioned along the periphery of the carousel 313. In the illustrated embodiment, each of the rods 456, 458 extends through a hole in the base 455. The base 455 can be rotated to position the preform with respect to the heat treatment system 312.

With reference to FIG. 4B, the upper ends 490, 492 of the rods 456, 458 can contact the contact pads 468, 470, respectively, to cause movement of the rods 456, 458 relative to the base 455. Springs 494, 496 disposed about a portion of the rods 456, 458, respectively, bias the ends 490, 492 toward the lever 454. When the carrier 374 travels along the carousel 313, the rollers 464, 484 can be disposed in a pair of tracks along the carousel 313. As the carrier 374 moves along the tracks, the distance between the tracks can be increased or decreased to move the rollers 464, 484 away from or toward each other. When the rollers 464, 484 are sufficiently close together, the lever 454 applies a force to the rods 456, 458 sufficient to overcome the bias of the springs 494, 496 thereby pushing the rods 456, 458 out of the ends of the cylindrical housings 500, 502, respectively. Each of the cylindrical housings 500, 502 can be disposed through a cylindrical passage 515 in the mandrel 420.

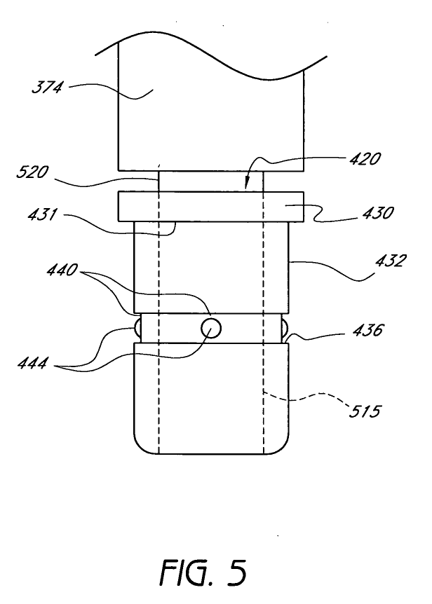

The diameter of the rods 456, 458 are varied such that at different positions relative to the housings 500, 502, protrusions 444 (FIG. 5), which are disposed through the openings 510, 512 of the corresponding housings 500, 502, are extended or retracted.

With reference again to FIG. 4, the carrier 374 can have a drive mechanism to engage a portion of the carousel 313 to cause rotation of the rods 456, 458 to rotate the preform 1. In the illustrated embodiment, a drive mechanism 503 has a drive gear 505 that can mate with teeth, a gear, a chain, and/or other structure of the carousel 313. As a carousel motor moves all of the carriers 374 along the carousel 313, the drive gear 505 of the drive mechanism 503 can cause rotation of the rods 456, 458 which, in turn, rotate the mandrels 420 and associated preform 1. Optionally, the rods 456, 458 can be interconnected by a belt. Alternatively, the rods can be independently driven by independent drive mechanisms.

With respect to FIGS. 5 and 6, the mandrels 420 can be disposed about the housings 500, 502 so that the rods 456, 458 can extend out of the lower ends of the mandrels 420. For example, the housing 500 can be disposed within the passage 515 of the mandrel 420. Optionally, the housing 500 and the mandrel 420 can be aligned so that one or more of the openings 510 of the housing 500 are aligned with the openings 440 of the mandrel 420. The protrusions 444 can therefore pass out of both the openings 440, 510. The housing 502 can be similarly aligned with another mandrel 420.

The carriers 374 can be connected in order to have carriers 374 that move together about the carousel system 372. Any suitable means, such as belts, linkages, tie rods, or the like can be used to interconnect the carriers 374. As such, the carriers 374 move in unison about the carousel system 372.

The mandrels 420 of the carriers 374 are configured to fit within and extend into the interior of the preforms. The mandrels 420 can be coupled to the cylindrical housings 500, 502 (FIG. 4B) of the carrier 374. The mandrels 420 can be operated to receive, hold, and/or release the preforms.

The illustrated mandrel 420 comprises a generally cylindrical elongated body that is sized to fit into the opening of a preform. Optionally, the mandrel 420 can extend into and along a substantial portion of the neck 32 of the preform 1. In another embodiment, the mandrel 420 can extend most of the way into the interior of the preform 1 and terminate along the body 34 of the preform. Preferably, at least a portion of the mandrel 420 is configured to engage the interior surface 16 of the preform 1.

At least a portion of the mandrel 420 can be moved to hold and/or release a preform. In some embodiments, at least a portion of the mandrel 420 can be moved radially inward and/or outward. For example, a portion of the mandrel 420 can move radially outward to engage and hold the interior surface 16 of the preform 1. As shown in FIG. 6, the mandrel 420 can have an expandable ring, such as a split ring 424. The ring 424 is an annular ring with a gap so that the ring can be moved in the radial direction. The mandrel of FIG. 5 is shown with the split ring removed.

With reference to FIGS. 5 and 6, the mandrel 420 can have an upper lip 430, a body 432, and a groove 436. The upper lip 430 can have a lower surface 431 that can contact the upper edge of a preform and function as a stop. When the preform is delivered to the carrier 374, the preform can be inserted over the mandrel 420 until the upper edge of the preform is near to or contacts the upper lip 430 of the mandrel 420.

The body 432 of the mandrel 420 is preferably sized to fit within the neck finish of the preform. The groove 436 and associated ring 424 are positioned along the body 432. The groove 436 can receive the inner portion of the ring 424.

As shown in FIG. 5, openings 440 along the groove 436 can have one or more protrusions 444 for causing radial movement of the split ring 424. In one embodiment, each protrusion 444 is a spherical body that can extend from a circular opening 440. When the protrusions 444 extend from the openings 440, the protrusions 444 push the ring 424 in the outwardly direction so that the outer surface of the ring 424 can apply sufficient pressure to the interior surface 16 to hold the preform. The protrusions 444 can be retracted into the body 432 of the mandrel 420, thus allowing the ring 424 to surround tightly the body 432. When the protrusions 444 are retracted, a preform can be loaded onto the mandrel 420 or released from the mandrel 420. Thus, each protrusion 444 can be moved between an extended position and retracted position in order to hold and release, respectively, a preform. The protrusions can have any shape suitable for engaging the inner surface of the ring 424. The mandrel 420 can comprise any number of openings 440 and corresponding protrusions 444. For example, in the illustrated embodiment, the mandrel 420 has four openings 440 and four corresponding protrusions 444. Preferably, the openings 440 and the protrusions 444 are positioned along the surface of the groove 436.

After preforms are fed onto the carriers 374, the carriers 374 can hold and transport the preforms to and through the heat treatment system 312. Preferably, the preforms are rotated about their longitudinal axis as they pass through the heat treatment system 312. The rotation of the preforms can ensure that the preforms are thoroughly and evenly processed, if desired.

The illustrated thermal processing system 369 can be used or modified with systems and devices described in U.S. Provisional Patent Application No. 60/586,854 entitled DIP, SPRAY, AND FLOW COATING PROCESS FOR FORMING COATED ARTICLES, and U.S. application Ser. No. 11/179,025, which are hereby incorporated by reference in their entirety and forms part of the disclosure of the present application. U.S. application Ser. No. 11/179,025, entitled DIP, SPRAY, AND FLOW COATING PROCESS FOR FORMING COATED ARTICLES, which also disclose additional transport systems, mandrel, apparatuses that can be used in combination with the devices, systems, methods, and techniques disclosed therein.

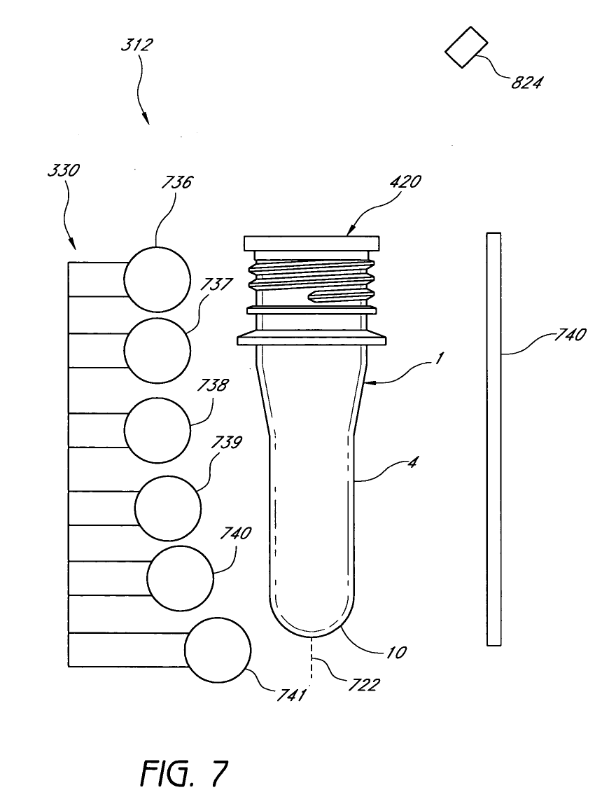

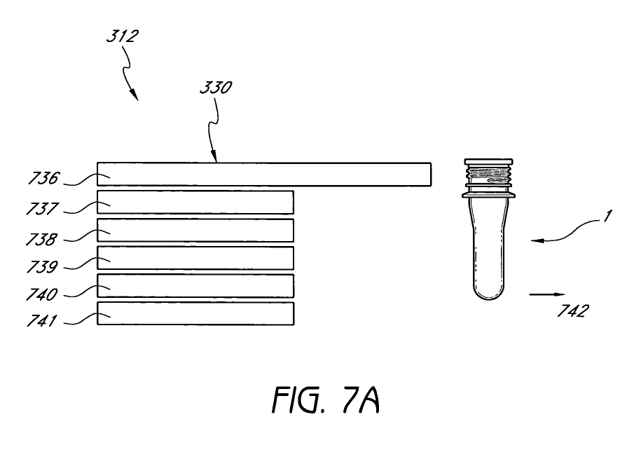

The physical orientation of the heat treatment system 312 is adjustable relative to the preforms. As shown in FIG. 7, the heat treatment system 312 comprises a heating unit or bank 330 that includes a plurality of energy sources in the form of lamps 736-741 that may be moved relative to the preform being held by the mandrel 420 (the carrier is not shown). Each lamp of the bank 330 can be independently moved towards and/or away from the preform 1. The distances between each lamp and the preform can be determined by the desired thermal processing of the preform. The preforms can be rotated about their longitudinal axis 722 as they pass by the heat treatment system 312 to achieve generally even heating. Thus, sections of the preform 1 can have a generally uniform temperature distribution.

The bank 330 is configured so that its lamps can be independently operated. Some of the lamps of the bank 330 can heat preforms for a different length of time than other lamps of the bank 330. The upper lamp 736 preferably heats the preform 1 for a longer time period than one or more of the lamps 737-741. The lamps 737-741 preferably do not heat the preform's body portion to a temperature above the crystallization temperature thereby preserving the amorphous state of the body of the preform 1. The lamps of the bank 330 can also output different amounts of energy. For example, the upper lamp 736 can output more energy than the other lamps. In such an embodiment, the upper lamp 736 can elevate the neck finish of the preform 1 to a higher temperature than the other portions of the preform 1.

If the preform 1 is coated with a material, the bank 330 can cure the coating while also causing crystallization of a portion of the preform. The preform 1 can be coated using the processes described in the pending U.S. patent application Ser. No. 11/179,025 entitled DIP, SPRAY, AND FLOW COATING PROCESS FOR FORMING COATED ARTICLES. The coating can be a liquid which is cured by the bank 330. Various types of coatings can be cured, dried, activated, or otherwise thermally processed by the heat treatment system 312.

With respect to FIG. 7A, the heat treatment system 312 can have lamps with different lengths to treat the illustrated preform moving along the processing line in the direction indicated by the arrow 742. The illustrated bank 330 of FIG. 7A is especially well suited to process a preform that is coated with a curable material. The coating can be applied to the body of the preform 1. The lamp 736 may be longer than the other lamps 737-741 so that the upper portion of the preform is processed longer than the lower portion of the preform. The lengths of the lamps can be selected based on the desired processing time. The preform 1 enters the left side of the bank 330 and is heated by the bank 330. The coating can be cured while the neck finish is crystallized. The preform eventually exits the right side of the bank 330. The preform 1 is shown after it has been thermally processed by the bank 330.

A skilled artisan can select the length and intensity of energy (e.g., IR energy) produced by the lamps 737-741 to achieve the desired thermal processing of the preform 1. Of course, the number and lengths of the lamps can be varied to achieve the desired temperature distributions through the preform.

The cooling rate of the preform can be increased or decreased to reduce or increase the amount of crystalline material of the preform. To form a crystalline neck finish, the neck finish of the preform can be heated by the bank 330 above a crystallization temperature. The neck is then slowly cooled to form the desired amount of crystalline material. The cooling rate can be increased or decreased to decrease or increase, respectively, the degree of crystallization. Alternatively, the neck finish of the preform can be heated by the bank 330 above a crystallization temperature for a target period of time. After crystallization, the preform can be rapidly cooled.

If the body of the preform has a curable coating, the bank 330 can heat the coating to an appropriate temperature to cure the coating, preferably without forming crystalline material. Thus, the bank 330 can rapidly cool portions of the preform 1 while other portions of the preform 1 are heated and then gradually cooled in order to produce crystalline material.

With reference again to FIG. 7, the heat treatment system 312 in one embodiment can have one or more reflectors 740 that can reflect output from the bank 330 towards the preforms. The reflector 740 can be used with IR lamps to provide thorough heating of the neck portion 32 of the preform. The lamps are positioned on one side of the processing line while the reflector 740 is located on the opposite side of the processing line. The reflector 740 advantageously reflects the output from the bank 330 back onto the preform allowing for a more rapid crystallization, and efficient use of the output of the bank's lamps. Although not illustrated, additional reflectors can be located at any suitable position relative to the preform to reflect IR rays from the lamps toward the preform. The reflector 740 may be generally flat and/or curved and may have a surface treatment in order to achieve the desired amount of reflected radiant waves.

Any number of heat treatment systems 312 can be used to heat preforms and cause crystallization. In one embodiment, the heat treatment system 312 comprises four units or banks each having six lamps. Although not illustrated, one or more banks of lamps can be used to surround various sections of the processing line. For example, a plurality of lamps can be positioned on one side of the processing line while another plurality of lamps is located on the opposite side of the processing line. The heat treatment systems can also be used in combination with any preform processing system, such as the system described in U.S. Provisional Patent Application No. 60/586,854.

The lamps of the heat treatment system 312 can be any energy source suitable for heating a preform to a desired temperature. The lamps can be 1000 W quartz IR lamps. A preferred source is a General Electric Q1500 T3/CL Quartzline Tungsten-Halogen lamp. This particular source and equivalent sources may be purchased commercially from any of a number of sources including General Electric and Phillips. The source may be used at full capacity, or it may be used at partial capacity such as at about 50%, about 65%, about 75% and the like. Preferred embodiments may use a single lamp or a combination of multiple lamps. For example, six IR lamps of the bank 330 may be used at 70% capacity. In one non-limiting embodiment, the lamps heat at least a portion of a preform sufficiently to cause amorphous material to crystallize into semi-crystalline or crystalline material, as detailed above. Preferably, the portion of the preform is heated to a temperature above its T_{g} to cause crystallization. Of course, preforms made of different materials may have a different T_{g}. The output of the lamps can be chosen based, at least in part, on the material forming the preform.

Optionally, the heat treatment system 312 can use one or more of the following: conduction, convection, and radiation to control the temperature of the preforms. For example, convection can be used to regulate the surface temperature of the preform, thereby providing flexibility for controlling the effectiveness of the radiant heat. In some embodiments, the heat treatment system 312 can have a flow system for providing a fluid flow that helps control the surface temperature of the preform. The fluid can be heated or chilled, as desired. Preferably, a chilled gas is used to form a boundary layer along the surface of the preform to reduce the surface temperature of the preform. When the surface of the preform is cooled, the radiant can penetrate and heat the preform without damaging the surface of preform due to undesirably high temperatures.

The heat treatment system 312 and carriers 374 can work alone or in combination to control the temperature of the preform. In some embodiments, the surface temperature of the outer portion of the preform 1 may exceed the T_{g} of the preform material without heating the inner surface 16 of the preform 1 above its T_{g} during the crystallization process. This may enable amorphous portions of the preform to become non-crystalline without distorting the preform shape due to overheating of the neck 32. In another embodiment, the semi-crystalline portions of the preforms may become crystalline without distorting the overall preform shape due to overheating. Preferably, the inner portions of the preform can be maintained below the preform's T_{g} while outer portions of the preform may be above their T_{g}, thereby causing crystallization of the outer portions only. In this manner, an amorphous preform can be made into the preform illustrated in FIGS. 2 and 2A The temperature gradient through the wall of the preform can be selectively controlled by using IR heating of the system 312 and cooling of the mandrel (as discussed below), although other methods may also be used.

In one embodiment illustrated in FIG. 6, the heat treatment system 312 has a mandrel temperature control system 419 for selectively controlling the temperature of the preform for the crystallization process. In one embodiment, the temperature control system 419 of the mandrel 420 comprises one or more channels 744 for controlling the temperature of the preform, preferably the neck finish 32 of the preform. The body 432 of the mandrel 420 can extend through a portion of the interior chamber of the preform 1. Heated or chilled fluid (e.g., gas and/or liquid) can pass through the mandrel 420 to control the temperature of the preform 1. In the illustrated embodiment, chilled fluid (e.g., refrigerant, water, or the like) can flow through the channels 744 to transfer heat away from the preform held on the mandrel 420. The working fluid can absorb and carry the heat away from the mandrel 420. As such, the mandrel 420 can continuously cool the preform disposed thereon. When the preform 1 is crystallized, the mandrel 420 can cool the inner portion of the preform 1 so that the preform remains coupled to the mandrel 420. Additionally, the transverse dimensions (e.g., the inner diameters) of the neck finish can be maintained due to the cooling of the mandrel 420.

With continued reference to FIG. 6, the channels 744 can be operated independently of one another. That is, a fluid at a first temperature (e.g., a high temperature) can be passed through at least one of the channels 744 and fluid at a second temperature (e.g., a low temperature) can be passed through at least one of the other channels 744. In such an embodiment, different portions of the preform can be maintained at different temperatures. The mandrel 420 can be used to heat and/or cool portions of the preform 1 before, during, and/or after the heat treatment system 312 thermally processes the preform 1.

The IR lamps of the heat treatment system 312 and the mandrel 420 can be used in combination to achieve a semi-crystalline or crystalline neck finish. The IR lamps can heat the preform while the mandrel 420 holds the preform and absorbs heat to ensure that the preform retains its shaped during thermal processing, as discussed above. Additionally, while the preform 1 and the mandrel 420 proceed along the processing line through the heat treatment system 312, the mandrel 420 and the preform 1 can rotate about the axis 722 of the preform 1 to further ensure a generally uniform heat distribution throughout one or more portions of the preform. In some embodiments, the dimensional stability of the preform is maintained due to its cooled inner layer or surface 16 contacting the cooled mandrel 420. The microstructure of the inner portion of the preform may remain generally unchanged because the mandrel 420 keeps the temperature of the inner portion at a sufficiently low temperature (e.g., below T_{g} of the preform), even when the outer portion of the preform is heated and undergoes crystallization.

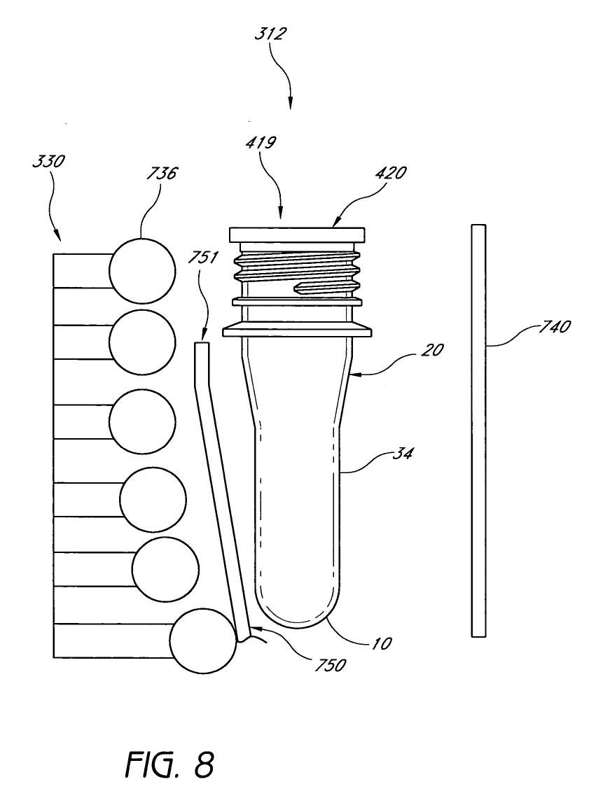

The heat treatment system 312 can have a structure or device for selectively controlling the amount of radiant heat that is delivered to the preform 1. In the illustrated embodiment of FIG. 8, a shield 750 may block at least a portion of the radiant heat from the bank 330. The shield 750 can block most or all of the radiation produced by one or more of the IR lamps. In some embodiments, the shield 750 permits transmission of selected wavelengths but does not transmit other wavelengths. An upper portion 751 preferably is positioned so that a limited amount of IR energy is delivered below the neck ring of the preform 1. In such embodiments, the amount of IR energy delivered to the body portion of the preform 1 is preferably insufficient to produce crystalline material that would noticeably effect the blow-molding process. If the body of the preform 1 is coated with a curable material, the heat treatment system 312 can heat and cure the coating without forming crystalline material. However, the heat treatment system 312 can simultaneously heat the preform to form a crystalline neck finish.

The shield 750 can be a piece of, e.g., metal or plastic that blocks at least a portion of the radiant heat output of the bank 330. The shield 750 can be sized and configured such that it extends along the body 34 to prevent radiation from heating portions of the preform above a predetermined temperature. Optionally, the shield 750 can comprise an opaque material or filter that permits some radiant heat produced by the lamps 736 to pass therethrough. Optionally, a plurality of shields 750 can be used to inhibit or prevent radiation from penetrating different portions of the preform. It is contemplated that one or more of the heat treatment systems 312 can have one or more of these types of shields 750. Additionally, the amount of radiant heat provided to portions of the preforms can be based on the dimensions of the preforms.

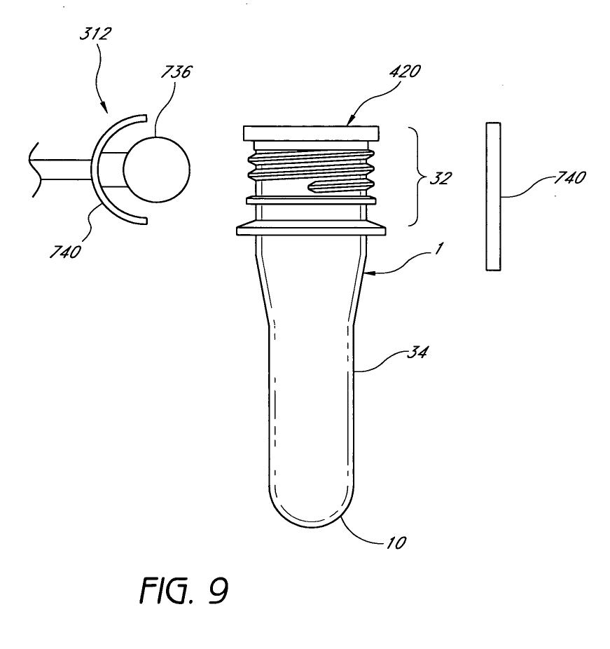

With respect to FIG. 9, the heat treatment system 312 can be adapted to direct thermal energy to a particular portion of a preform. The illustrated heat treatment system 312 has a lamp 736 that heats the upper portion of the preform 1. The heat treatment system 312 preferably has a reflector 740 or other structure designed to direct energy outputted from the heat treatment system 312 towards selected portion(s) of the preform 1. In some embodiments, direct radiation from the lamp 736 and reflected radiation from the reflector 740 work in combination to ensure that a substantial portion of the neck 32 reaches a threshold temperature for crystallization. Hence, the heat treatment system 312 can direct energy to specific areas of a preform for precise processing.

The body 34 of the preform 1 preferably remains substantially amorphous for subsequent blow molding. However, one or more portions of the body 34 may be crystallized. An upper portion of the body 34 near the neck ring 38 may undergo minimal crystallization. A skilled artisan can determine the desired amount and location(s) of crystallization to achieve desired characteristics for blow molding of the preform.

Any number of heat treatment systems 312 of FIG. 9 can be employed to treat a preform. To maintain a plurality of regions of a preform at different temperatures, a corresponding number of heat treatment systems 312 can be used to heat the target regions of the preform to particular temperatures.

In operation, the carousel 313 can move the preforms along the processing line and through the heat treatment system 312. The heat treatment system 312 can then crystallize a portion of the preform. To crystallize a portion of the preform, the temperature of amorphous material of the preform can be increased above its crystallization temperature. For example, at least a portion of the neck finish 32 can be heated to a temperature (i.e., a crystallization temperature) that may be between the preform's glass transition temperature (T_{g}) and its melt temperature (Tₘ). When the material of the preform is within this range, the mobility of the polymers in the preforms is greatly increased, thereby allowing crystallization. The length of time at which the preform is maintained at an elevated temperature can be increased to increase the weight percentage of semi-crystalline or crystalline material in the preform. After crystallization, the temperature of the preform can be lowered until reaching a temperature suitable for handling. During the crystallization process, a portion of the neck finish 32 remains at a temperature below the preform's T_{g} for increased dimensional stability, especially if the preform is held by a mandrel.

The processed preform preferably has a body portion that comprises an amorphous or semi-crystalline material, while the neck portion preferably comprises mostly crystalline material. In some embodiments, the body portion is primarily amorphous or semi-crystalline, and the neck portion is primarily crystalline. Optionally, the mandrel 420 can cool the inner surface 16 of the preform 1 to ensure that at least a portion of the preform 1 remains below its crystallization temperature, even though the outer portion of the preform 1 is at a relatively high temperature causing amorphous material to crystallize. However, any portion of the preform can be heated to cause amorphous material to crystallize. In one embodiment, for example, the neck finish 32 is heated to an elevated temperature causing amorphous material in the neck finish 32 to become generally semi-crystalline or generally crystalline, while at least a substantial portion of the body 34 of the preform remains amorphous. In one non-limiting embodiment, after the preform 1 is thermally processed, it has the neck finish 32 with a crystalline content that is more than about 20% by weight. In one non-limiting embodiment, the neck finish 32 has a crystalline content that is more than about 10% by weight, including 30%, 40%, 50%, 60%, 70%, 80%, 90%, and about 99% by weight. In one non-limiting embodiment, the neck finish 32 has a semi-crystalline content that is more than about 30% by weight, including 40%, 50%, 60%, 70%, 80%, 90%, and about 99% by weight. In some embodiments, the neck finish 32 has crystalline or semi-crystalline content of about 100% by weight. As the preforms move along the processing line, the preforms can be rotated about their longitudinal axes at a speed of about 30-80 RPM. The line speed, length of the lamps of the bank 330, number and position of the lamps, and the energy outputted by the lamps can be varied by one of ordinary skill in the art to obtain the desired heat distribution in the preform.

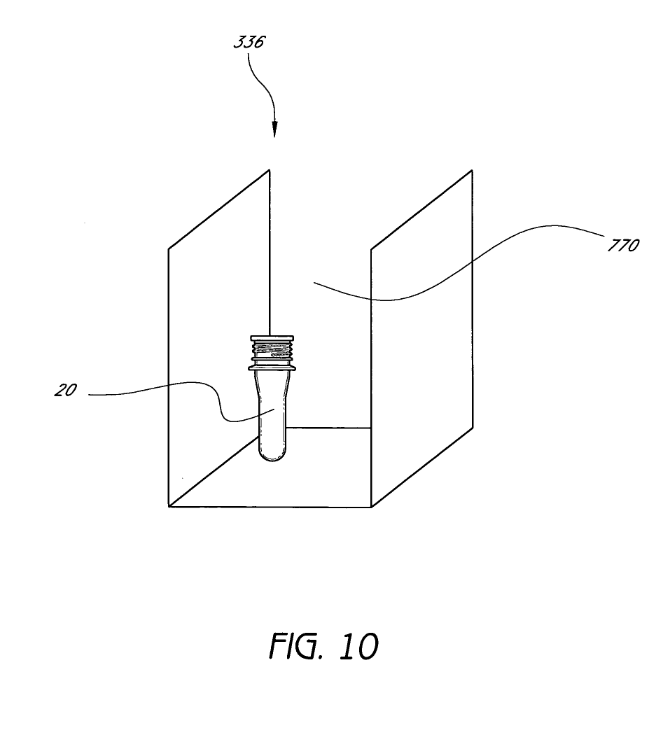

After the preforms undergo the heating process, the preforms can be cooled. The cooling process can comprise using ambient air, with or without forced convection. The rate of cooling of the preform 1 can be selectively controlled to achieve the desired microstructure of the preform. For example, the rate of cooling may be reduced to increase the crystalline material by weight percentage of the preform. In another embodiment, the cooling process is accelerated by the use of forced chilled air to reduce the ratio of crystalline to amorphous material in the preform. In the illustrated embodiment of FIG. 10, the cooling system 336 can comprise a channel 770 through which a blower or fan (not shown) can pump, for example, ambient air or chilled air. The air cools the preforms which are held by the carriers 374 and carried down the length of the channel 770. It is contemplated that any suitable means can be employed to cool the heated portions of the preforms. After the preforms are sufficiently cooled for handling, they are released from the carriers 374 and transported away by the removal system 346, which can be a conveyor system. The preforms can then be processed, e.g., blow molded and then hot-filled.

Optionally, the heat treatment system 312 can have one or more temperature sensors 824 (FIG. 7). The temperature sensors can be optical pyrometers that may be carefully positioned along the processing line to measure the temperature of the preforms. Advantageously, the pyrometers can determine the preforms' temperatures directly by measuring the light radiation emitted by the preforms. Thus, the temperature of the preforms can be obtained without contacting and possibly damaging the preforms. However, other temperature devices can also be used to measure the temperature of the preforms. For example, a thermocouple on the mandrel can be used to measure the temperature of a preform. Other types of temperature sensors can also be used, if desired.

The heat treatment system 312 can be a closed loop or open loop system. For example, the heat treatment system 312 can be a closed loop system, whereby the power to the lamps is controlled based upon feedback signals from one or more temperature sensors (e.g., pyrometers) and can then adjust the amount of radiant heat produced by the lamps based on those readings. Alternatively, the heat treatment system 312 can be an open loop system wherein the amount of radiant heat produced by the lamps is set by user input. For example, the lamps may be set to a fixed power mode. It is contemplated that the heat treatment system 312 can be switched between a closed and open loop system.

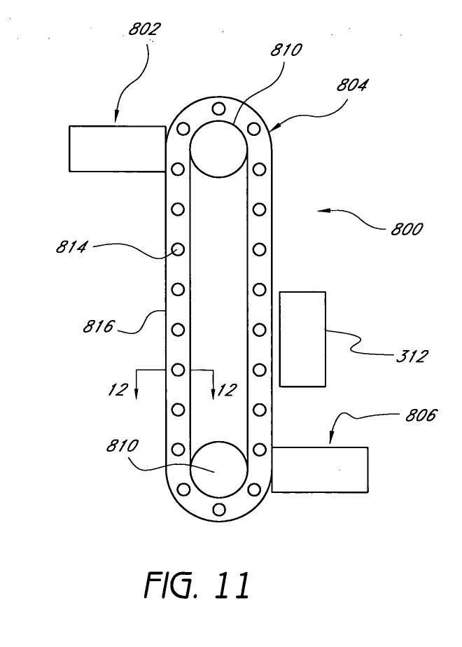

FIG. 11 is a top view of a thermal processing system 800 for producing preforms comprising crystalline material. The thermal processing system 800 comprises a feed system 802, a carousel 804, the heat treatment system 312, and an output system 806. The feed system 802 is configured to deliver preforms to the carousel 804. A pair of drive systems 810 drives the carousel 804 in order to move the preforms along a processing line, either clockwise or counterclockwise. The heat treatment system 312 causes crystallization of at least a portion of each preform. The output system 806 can receive preforms from the carousel 804 and can then transfer the preforms away from the thermal processing system 800. The carousel 804 comprises a plurality of movable carriers 814 configured to hold and transport preforms.

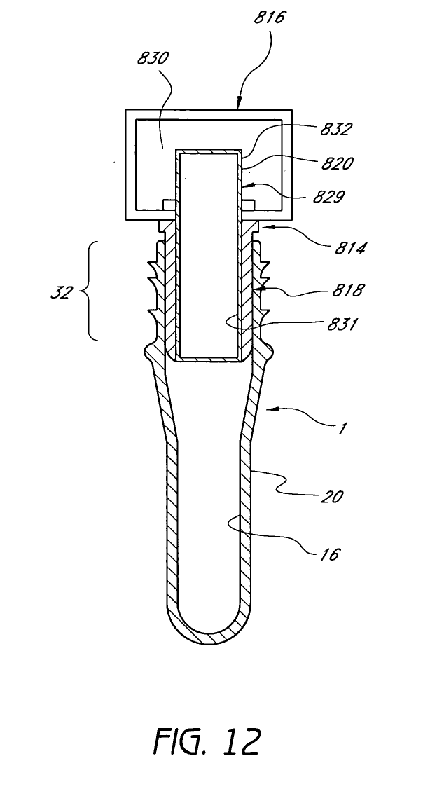

FIG. 12 is a cross-sectional view of the carousel 804 taken along a line 12-12 of FIG. 11. The carrier 814 is configured to control the temperature of the preform 1. The carrier 814 can be generally similar to the carrier 374, except as described in further detail below.

The carrier 814 is configured to fit within the opening defined by the neck finish 32 of the preform 1 (FIG. 2). The carrier 814 comprises a mandrel 818 and a mandrel temperature control system 829. The mandrel temperature control system 829 can heat and/or cool the mandrel 818. The illustrated system 829 includes a heat tube 820 configured to draw heat upwardly away from the mandrel 818. The heat tube 820, in turn, can be cooled by forced convection via air flowing through the rail 816.

The heat tube 820 has a lower portion 831 and an upper portion 832. In such an embodiment, at least a portion of the heat tube 820 is preferably positioned within the inner chamber 830 defined by the rail 816. Fluid (e.g., chilled air, refrigerant, or other cooling fluids) can be passed through the inner chamber 830 to cool the upper portion 832.

During operation, heat from the preform 1 is transferred to the mandrel 818. The heat can be generated by a process designed to form crystalline material, such as the processes described above. Heat is conducted through the mandrel 818 to the lower portion 831 which, in turn, transfers the heat upwardly to the upper portion 832. Chilled air is forced through the chamber 830 so that the air absorbs heat from the tube 820, although other fluids can also be employed. The fluid can be delivered with or without forced convection. In some embodiments, the heat tube 820 is exposed to ambient air which cools the heat tube. In this manner, heat is absorbed and dissipated by the heat tube 820.

In some embodiments, the carrier 814 can rotate the preform 1 about the longitudinal axis of the preform. If the heat treatment system 312 comprises heat lamps, the carrier 814 preferably rotates the preform 1 for a more uniform temperature distribution when the carrier 814 carries the preform past the heat treatment system 312. However, in other embodiments, the carrier 814 may not rotate the preform 1 about its longitudinal axis. By way of example, the carrier 814 can carry the preform 1 along the processing line without rotating the preform.

The mandrels described herein can be made of any material suitable for transferring heat away from the preform. For example, the mandrel 818 can be formed of steel, aluminum, metal alloys, plastics, rubber, or other suitable materials. In some embodiments, at least a portion of the mandrel 818 comprises a high heat transfer material for efficient heat transfer between the preform 1 and the heat tube 820 via the mandrel 818. The high heat transfer material can result in rapid cooling of a neck finish 32, even at reduced flow rates of the fluid passing through the chamber 830. The high heat transfer material can include, but is not limited to, a beryllium-free copper alloy (sold under the tradename AMPCOLOY), aluminum, copper and its alloys, or other materials with a high thermal conductivity.

The heat tube 820 can contain a fluid or gas that aids in the transfer of heat from the lower portion 831 to the upper portion 832 of the heat tube 820. The fluid can circulate within the heat tube 820 as the fluid is heated and cooled in order to cool the lower portion 831. In some embodiments, the heat tube 820 can have a system for pumping fluid through the heat tube 820. Alternatively, the heat tube 820 may be a solid rod that is preferably formed of an especially high heat transfer material, such as copper.

In another embodiment not illustrated, the heat tube 820 can contact one of the vertical side walls of the rail system 816 in order to conduct heat from the heat tube 820 to the rail system 816. Thus, forced convection and/or conduction can be used to cool the heat tube 820, thereby cooling the mandrel 818 which, in turn, cools the neck finish 32 of the preform 1. In some embodiments, the heat tube 820 is perforated so that air can flow through the tube 820 to further enhance heat dissipation.

In operation, the feed system 802 delivers preforms to the carousel 804. In some embodiments, including the illustrated embodiment, the carousel 804 moves the preforms in a clockwise direction along a processing line. The preforms are heated as they pass by the system 312. The carriers 814 cool the inner surface of the preform 1 to ensure that at least a portion of the preform 1 remains below its T_{g} as the preform 1 heated by the system 312. Preferably, when the preform 1 is heated by the system 312, the outer surface of the preform 1 is at a high temperature causing crystallization. The inner portion of the neck portion 32 thus comprises more amorphous material than the outer portion of the preform. However, any portion of the preform can be heated to cause crystallization of amorphous material. As such, the system 800 can be used to produce preforms with a semi-crystalline or crystalline neck finish. Other types of preforms can also be formed utilizing the system 800. The carousel 804 then delivers the processed preforms to the output system 806 for ejection.

All patents and publications mentioned herein are hereby incorporated by reference in their entireties. Except as further described herein, certain embodiments, features, systems, devices, materials, methods and techniques described herein may, in some embodiments, be similar to any one or more of the embodiments, features, systems, devices, materials, methods and techniques described in U.S. Pat. Nos. 6,109,006; 6,808,820; 6,528,546; 6,312,641; 6,391,408; 6,352,426; 6,676,883; U.S. patent application Ser. Nos. 09/745,013 (Publication No. 2002-0100566); 10/168,496 (Publication No. 2003-0220036); 09/844,820 (2003-0031814); 10/090,471 (Publication No. 2003-0012904); 10/395,899 (Publication No. 2004-0013833); 10/614,731 (Publication No. 2004-0071885), provisional application 60/563,021, filed Apr. 16, 2004, provisional application 60/575,231, filed May 28, 2004, provisional application 60/586,399, filed Jul. 7, 2004, provisional application 60/620,160, filed Oct. 18, 2004, provisional application 60/621,511, filed Oct. 22, 2004, and provisional application 60/643,008, filed Jan. 11, 2005, U.S. patent application Ser. No. 11/108,342 entitled MONO AND MULTI-LAYER ARTICLES AND COMPRESSION METHODS OF MAKING THE SAME, filed on Apr. 18, 2005, U.S. patent application Ser. No. 11/108,345 entitled MONO AND MULTI-LAYER ARTICLES AND INJECTION METHODS OF MAKING THE SAME, filed on Apr. 18, 2005, U.S. patent application Ser. No. 11/108,607 entitled MONO AND MULTI-LAYER ARTICLES AND EXTRUSION METHODS OF MAKING THE SAME, filed on Apr. 18, 2005, which are hereby incorporated by reference in their entireties. In addition, the embodiments, features, systems, devices, materials, methods and techniques described herein may, in certain embodiments, be applied to or used in connection with any one or more of the embodiments, features, systems, devices, materials, methods and techniques disclosed in the above-mentioned patents and applications.

The various methods and techniques described above provide a number of ways to carry out the invention. Of course, it is to be understood that not necessarily all objectives or advantages described may be achieved in accordance with any particular embodiment described herein.

Furthermore, the skilled artisan will recognize the interchangeability of various features from different embodiments. Similarly, the various features and steps discussed above, as well as other known equivalents for each such feature or step, can be mixed and matched by one of ordinary skill in this art to perform methods in accordance with principles described herein.

Although the invention has been disclosed in the context of certain embodiments and examples, it will be understood by those skilled in the art that the invention extends beyond the specifically disclosed embodiments to other alternative embodiments and/or uses and obvious modifications and equivalents thereof. Accordingly, the invention is not intended to be limited by the specific disclosures of preferred embodiments herein.

What is claimed is:

1. A heat treatment system for crystallizing a portion of a preform comprising:
an energy source configured to output thermal energy; and
a mandrel adapted to hold a preform such that the preform is heated to a crystallization temperature to reduce an amount of amorphous material of the preform when the energy source outputs a predetermined amount of thermal energy.

2. The heat treatment system of claim 1, wherein the energy source is positioned and configured to elevate the temperature of the preform at the crystallization temperature for a sufficient length of time so that a neck portion of the preform comprises primarily crystalline material while a body portion of a preform comprises primarily non-crystalline material.

3. The heat treatment system of claim 1, wherein the energy source comprises at least one infrared lamp.

4. The heat treatment system of claim 4, wherein the energy source is a plurality of infrared lamps movable relative the mandrel.

5. The heat treatment system of claim 1, wherein the mandrel has a mandrel temperature control system for cooling the preform.

6. The heat treatment system of claim 5, wherein the mandrel temperature control system comprises a plurality of cooling channels.

7. A heat treatment system for crystallizing a portion of a preform, the heat treatment system comprising:
a thermal processing system configured to output thermal energy; and
a transport system comprising a plurality of carriers, each carrier being movable along a processing line extending alongside the thermal processing system, each carrier having at least one mandrel that is adapted to hold a preform while the thermal processing system outputs a sufficient amount of thermal energy to cause crystallization of at least a portion of the preform.

8. The heat treatment system of claim 7, further comprising blow molding the peform into a container.

9. The heat treatment system of claim 7, wherein the thermal processing system comprises at least one infrared lamp positioned near the processing line.

10. The heat treatment system of claim 7, wherein the mandrel is dimensioned so as to fit within in an interior of a neck finish of the preform, and the mandrel has a mandrel cooling system configured to cool the neck finish such that the interior of the neck finish is maintained below its glass transition temperature while the at least the portion of the preform is crystallized.

11. The heat treatment system of claim 7, wherein the mandrel has a cooling system for removing heat from the preform.

12. A method for heating a preform, the method comprising:
holding a preform comprising amorphous material by a carrier that moves the preform along a processing line;
moving the preform by a thermal processing system; and
heating at least a portion of the preform with the thermal processing system until the amorphous material by weight percentage of the preform has been reduced.

13. The method of claim 12, wherein the step of heating forms a crystalline neck finish of the preform.

14. The method of claim 12, wherein the heating of the at least a portion of the preform comprises heating a neck finish of the preform above a crystallization temperature.

15. The method of claim 14, further comprising cooling the heated neck finish to form a crystalline neck finish.

16. The method of claim 12, further comprising rotating the preform about its longitudinal axis as the preform is moved past the thermal processing system.

17. The method of claim 12, further comprising holding a preform with a rotatable mandrel that is attached to the carrier.

18. The method of claim 12, further comprising cooling an elongated mandrel of the carrier that holds the preform while the preform is heated.

19. The method of claim 12, wherein the heating of the preform produces a body portion of the preform that comprises mostly non-crystalline material and a neck portion of the preform that comprises mostly crystalline material.

20. The method of claim 19, wherein the neck portion of the preform comprises mostly crystalline material.

21. A method of heating a preform, comprising:
holding a preform on a mandrel, the preform has a neck finish portion comprising primarily amorphous material and a body portion comprising primarily amorphous material; and
delivering thermal energy to preform until the body portion of the preform is primarily amorphous or semi-crystalline, and the neck finish portion is primarily crystalline.

22. The method of claim 21, wherein the neck finish portion is maintained at a first temperature while the body portion of the preform is maintained at a second temperature, the first temperature is greater than a crystallinity temperature of the material forming the neck fish portion, and the second temperature is less than the crystallinity temperature.

23. The method of claim 21, wherein the thermal energy is infrared radiation.

24. The method of claim 21, further comprising actively cooling the mandrel while amorphous material of the neck finish portion crystallizes.
